(19) United States
(12) Patent Application Publication
(10) Pub. No.: US 2011/0285939 A1
(43) Pub. Date: Nov. 24, 2011

(54) LIQUID CRYSTAL DISPLAY DEVICE

(75) Inventors: Hiroko Nakashima, Kagawa (JP); Akiyoshi Kanemitsu, Ehime (JP); Yasuhiro Sekiguchi, Ehime (JP)

(73) Assignee: Sumitomo Chemical Company, Limited, Tokyo (JP)

(21) Appl. No.: 12/998,822

(22) PCT Filed: Dec. 3, 2009
(86) PCT No.: PCT/JP2009/070299

§ 371 Date: Aug. 3, 2011

(30) Foreign Application Priority Data
Dec. 4, 2008 (JP) 2008-310013

(51) Int. Cl. G02F 1/13357

(52) U.S. Cl. 349/64

(57) ABSTRACT

The present invention aims to provide a liquid crystal display capable of providing natural color display not tinged with red when viewed from an oblique front direction as well as when seen from a direct front direction. The liquid crystal display device of the present invention includes a light diffusing optical member (3), a light source (2) arranged on a rear surface side of the optical member (3), and a VA type liquid crystal panel (30) arranged on a front surface side of the optical member (3). The light diffusing optical member (3) is made of a transparent material in which light diffusing particles are dispersed. A relational expression of 0.01≦Δn×D₅₀≦0.25 is satisfied, where Δn is an absolute value of a difference between a refraction index of the transparent material and a refraction index of the light diffusing particles, and D₅₀ (μm) is an accumulative 50% particle diameter of the light diffusing particles. A light converging optical member (4) is arranged between the light diffusing optical member (3) and the light source (2).

### TECHNICAL FIELD

The present invention relates to a VA type liquid crystal display device capable of providing natural color not tinged with red even when seen from an oblique direction thereof as well as from a front direction thereof.

### BACKGROUND ART

As a liquid crystal display device, it is known that a liquid crystal display device is constituted by a vertical alignment liquid crystal cell in which liquid crystal molecules are sealed in between a pair of transparent electrodes, the liquid crystal molecules being configured to be oriented approximately in a vertical direction when no voltage is applied and oriented approximately in a horizontal direction when a voltage is applied (see Patent Document 1). The liquid crystal display device using the vertical alignment liquid crystal cell (VA type liquid crystal cell) has advantages high in contrast and high in response.

The aforementioned conventional VA type liquid crystal display device had a problem that it provided a color display tinged with red when seen from an oblique direction thereof although it provided a natural color display when seen from a front direction thereof. In other words, there is a drawback that the image display seen from an oblique direction thereof looks reddish and a high quality image display cannot be attained.

In order to solve the above-mentioned problem, the present applicant proposed a liquid crystal display device including a light diffusing plate, a light source arranged on a rear surface side of the light diffusing plate, and a liquid crystal panel arranged on a front surface side of the light diffusing plate. The liquid crystal panel includes a liquid crystal cell in which a liquid crystal is sealed in between a pair of transparent electrodes arranged at a distance from each other, molecules of the liquid crystal being configured to be oriented approximately vertically with respect to the transparent electrodes in a state in which no voltage is applied between the pair of transparent electrodes. The light diffusing plate is made of a transparent material in which light diffusing particles are dispersed. A relational expression of 0.01≦Δn×D₅₀≦0.25, a relational expression of 0.61≦Δn×D₅₀≦0.75 is satisfied, where Δn is an absolute value of a difference between a refraction index of the transparent material and a refraction index of the light diffusing particles, and D₅₀ (μm) is a 50% cumulative particle diameter of the light diffusing particles. (see Patent document 2)

### PRIOR ART DOCUMENTS

### Patent Documents

[Patent Document 1] JP-A-2002-365636
[Patent Document 2] JP-A-2008-116725

### SUMMARY OF THE INVENTION

### Problems to be Solved by the Invention

According to the liquid crystal display device disclosed by the aforementioned Patent Document 2, it is possible to attain a natural and high-quality color display sufficiently suppressed in a red-tinged color even when seen from an oblique direction thereof as well as when seen from a front direction thereof.

Since a further enhanced red-tinged color suppressing effect when seen from an oblique direction thereof can attain a higher quality color display, it is preferable to further enhance the red-tinged color suppressing effect when seen from an oblique direction thereof.

In general, in a structure in which a light-emitting diode is used as alight source, there is a tendency that a red-tinged color becomes more notably when seen from an oblique direction thereof as compared with the case in which another light source is used. For this reason, in cases where a light-emitting diode is used as a light source, it has been demanded to sufficiently suppress the red-tinged color when seen from an oblique direction thereof.

The present invention was made in view of the aforementioned technical background, and aims to provide a liquid crystal display device capable of providing natural high-quality color display not tinged with red when seen from an oblique direction thereof as well as when seen from a front direction thereof.

### Means for Solving the Problems

The present invention provided the following means to attain the aforementioned objects.

[1] A liquid crystal display device includes:

a first light diffusing optical member;

a light source arranged on a rear surface side of the first light diffusing optical member; and

a liquid crystal panel arranged on a front surface side of the first light diffusing optical member,

wherein the liquid crystal panel includes a liquid crystal cell in which a liquid crystal is sealed in between a pair of transparent electrodes arranged at a distance from each other, molecules of the liquid crystal being oriented approximately vertically with respect to the transparent electrodes in a state in which no voltage is applied between the pair of transparent electrodes,

wherein the first light diffusing optical member is made of a transparent material in which light diffusing particles are dispersed,

wherein a relational expression of 0.01≦Δn×D₅₀≦0.25 is satisfied, where Δn is an absolute value of a difference between a refraction index of the transparent material and a refraction index of the light diffusing particles, and D₅₀ (μm) is a 50% cumulative particle diameter of the light diffusing particles, and

wherein a light converging optical member is arranged between the first light diffusing optical member and the light source.

[2] The liquid crystal display device as recited in the aforementioned Item 1, wherein the light conversing optical member has, when an incident light having a half width at half maximum of 60° or more, the half width at half maximum being defined as a half of angular range between two points corresponding to a half of a maximum value of brightness of an incident angle-brightness curve showing each brightness of an incident angle of an incident light, is projected to the light conversing optical member, a light conversing performance capable of reducing a half width at half maximum of an output angle-brightness curve of an outgoing light output from the light converging optical member by 10° or more than a half width at half maximum of an incident light.

[3] The liquid crystal display device as recited in the aforementioned Item 1, wherein the light conversing optical member is a prism sheet,

wherein the prism sheet has, when an incident light having a half width at half maximum of 60° or more is projected to the light conversing optical member, the half width at half maximum being defined as a half of angular range between two points corresponding to a half of a maximum value of brightness of an incident light-brightness curve showing each brightness of an incident angle of an incident light, a light conversing performance capable of reducing a half width at half maximum of an output angle-brightness curve of an outgoing light output from the light converging optical member by 10° or more than a half width at half maximum of an incident light.

[4] The liquid crystal display device as recited in the aforementioned Item 1, wherein the light conversing optical member is a light diffusing sheet,

wherein the light diffusing sheet has, when an incident light having a half width at half maximum of 60° or more is projected to the light conversing optical member, the half width at half maximum being defined as a half of angular range between two points corresponding to a half of a maximum value of brightness of an incident light-brightness curve showing each brightness of an incident angle of an incident light, a light conversing performance capable of reducing a half width at half maximum of an output angle-brightness curve of an outgoing light output from the light converging optical member by 10° or more than a half width at half maximum of an incident light.

[5] The liquid crystal display device as recited in the aforementioned Item 1, wherein the light conversing optical member is a surface shaped light diffusing optical member,

wherein the surface shaped light diffusing optical member has, when an incident light having a half width at half maximum of 60° or more is projected to the light conversing optical member, the half width at half maximum being defined as a half of angular range between two points corresponding to a half of a maximum value of brightness of an incident light-brightness curve showing each brightness of an incident angle of an incident light, a light conversing performance capable of reducing a half width at half maximum of an output angle-brightness curve of an outgoing light output from the light converging optical member by 10° or more than a half width at half maximum of an incident light.

[6] The liquid crystal display device as recited in any one of the aforementioned Items 1 to 5, wherein a second light diffusing optical member is arranged between the light conversing optical member and the light source.

[7] The liquid crystal display device as recited in any one of the aforementioned Items 1 to 6, wherein the light source is a light-emitting diode.

### Effects of the Invention

According to the invention [1], when the relational expression of 0.01≦Δn×D₅₀≦0.25 is satisfied in the first light diffusing optical member, the diffusion light passed through the first light diffusing optical member in an oblique direction becomes tinged with blue, which counterbalances (countervail) the tinge of color (blue and red) with the phenomenon by which a reddish tone is given when the light passed through the first light diffusing optical member passes a VA type liquid crystal panel in an oblique direction. This results in a natural and high-quality color display not tinged with red when seen from an oblique direction thereof as well as when seen from a front direction thereof. Furthermore, the arrangement of the light converging optical member between the first light diffusing optical member and the light source can further enhance the red-tinged color suppressing effect when seen from an oblique direction.

According to the invention [2] to [5], the light conversing optical member has, when an incident light having a half width at half maximum of 60° or more, the half width at half maximum being defined as a half of angular range between two points corresponding to a half of a maximum value of brightness of an incident light-brightness curve showing each brightness of an incident angle of an incident light, is projected to the light conversing optical member, a light conversing performance capable of reducing a half width at half maximum of an output angle-brightness curve of an outgoing light output from the light converging optical member by 10° or more than a half width at half maximum of an incident light. This can further enhance the red-tinged color suppressing effect when seen from an oblique direction.

According to the invention [4] and [5], the light conversing optical member has a light converging function and a light diffusing function, which further enhances the red-tinged color suppressing effect when seen from an oblique direction and further diffuses the light.

According to the invention [6], since a second light diffusing optical member is arranged between the light conversing optical member and the light source, the lighting unevenness of the light source can be sufficiently diffused, resulting in an image having more even brightness within a liquid crystal panel.

According to the invention [7], regardless that a light-emitting diode is used as a light source, it is possible to provide a natural high-quality color display not tinged with red when seen from an oblique direction thereof as well as when seen from a front direction thereof.

### BRIEF DESCRIPTION OF DRAWINGS

FIG. 1 is a schematic side view showing an embodiment of a liquid crystal display device according to the present invention.

FIG. 2 is a schematic side view showing another embodiment of a liquid crystal display device according to the present invention.

FIG. 3 is a graph showing an example of an incident angle-brightness curve and an outgoing angle-brightness curve of a light converging optical member used in the present invention. In FIG. 3, “M” denotes a half width at half maximum of the incident light, and “N” denotes a half width at half maximum of the outgoing light. Please note that these incident angel-brightness curve and outgoing angle-brightness curve each only shows the half width side and these curves are approximately line symmetry with respect to the vertical line of the angle 0°.

### EMBODIMENTS FOR CARRYING OUT THE INVENTION

An embodiment of a liquid crystal display device 1 according to the present invention is shown in FIG. 1. This liquid crystal display device 1 is provided with a surface light source device 9 and a liquid crystal panel 30 arranged on a front surface side of the surface light source device 9.

The liquid crystal panel is equipped with a liquid crystal cell 20 in which a liquid crystal 11 is sealed in between a pair of upper and lower transparent electrodes 12 and 13 arranged in parallel with each other at a distance from each other, and polarizing plates 14 and 15 arranged upper and lower sides of the liquid crystal cell 20. These structural members 11, 12, 13, 14, and 15 constitute an image displaying portion. On the inner surface (liquid crystal side surface) of each of the transparent electrodes 12 and 13, an oriented film (not shown) is laminated.

It is configured such that the molecules of the liquid crystal 11 are oriented in a direction approximately perpendicular to (including “perpendicular to”) the transparent electrodes 12 and 13 in a state in which no voltage is applied between the pair of transparent electrodes 12 and 13, while the molecules are oriented in approximately parallel (including “parallel”) with each other (oriented in an approximately horizontal direction) when a voltage is applied between the pair of transparent electrodes 12 and 13. That is, as the liquid crystal cell 20, a vertical alignment liquid crystal cell is used.

The surface light source device 9 is arranged on a lower surface side (rear surface side) of the lower polarizing plate 15. This surface light source device 9 includes a thin box-shaped lamp box 5 having an opened upper surface side (front surface light source device side) and rectangular in shape as seen from the top, a plurality of light sources 2 arranged in the lamp box 5 at distances, a first light diffusing optical member 3 arranged on the upper side (front surface side) of the plurality of light sources 2, and the light converging optical member 4 arranged between the first light diffusing optical member 3 and the light source 2. The first light diffusing optical member 3 and the light conversing optical member 4 are fixed to the lamp box 5 so as to close the opened surface of the lamp box 5. The lamp box 5 has a light reflection layer (not shown) formed on the inner surface thereof.

This embodiment employs the structure in which the first light diffusing optical member 3 and the light converging optical member 4 are arranged one on the other in a contact manner (see FIG. 1). However, the present invention is not limited to such arrangement, and can employ a structure in which, for example, the first light diffusing optical member 3 and the light converging optical member 4 are arranged in parallel with each other in a non-contact manner via a slight air layer therebetween.

The first light diffusing optical member 3 is made of, e.g., a sheet or a film having a composition in which light diffusing particles are dispersed in a transparent material.

The first light diffusing optical member 3 is constituted so as to satisfy the following relational expression. That is, a relational expression of 0.01≦Δn×D₅₀≦0.25 is satisfied, where Δn is an absolute value of a difference between a refraction index of the transparent material and a refraction index of the light diffusing particles, and D₅₀ (μm) is a 50% cumulative particle diameter of the light diffusing particles. In other words, the first light diffusing optical member 3 is constituted by the transparent material and light diffusing particles satisfying the above relational expression.

In the aforementioned VA type liquid crystal display device 1, since the first light diffusing optical member 3 has a structure which satisfies the relational expression of 0.01≦Δn×D₅₀≦0.25, the diffusion light passed through the first light diffusing optical member 3 in an oblique direction becomes tinged with blue. Thereafter, by the phenomenon that the light becomes tinged with red by passing through the liquid crystal panel 30, the tinges of color (blue/red) are counterbalanced (countervailed) with each other. As a result, it becomes possible to attain a natural and high-quality color display not tinged with red when the liquid crystal panel 30 is seen from an oblique direction thereof. Furthermore, the arrangement of the light converging optical member 4 between the first light diffusing optical member 3 and the light source 2 can further enhance the red-tinged color suppressing effect when seen from an oblique direction. In addition, the diffusion light passed through the first light diffusing optical member 3 having the aforementioned structure in the front direction is white in color, which also can attain a natural and high-quality color display when seen from the front direction.

When the first light diffusing optical member satisfies the relational expression of Δn×D₅₀<0.01, or 0.25<Δn×D₅₀, the VA type liquid crystal display device presents a color display tinged with red when seen from an oblique direction thereof.

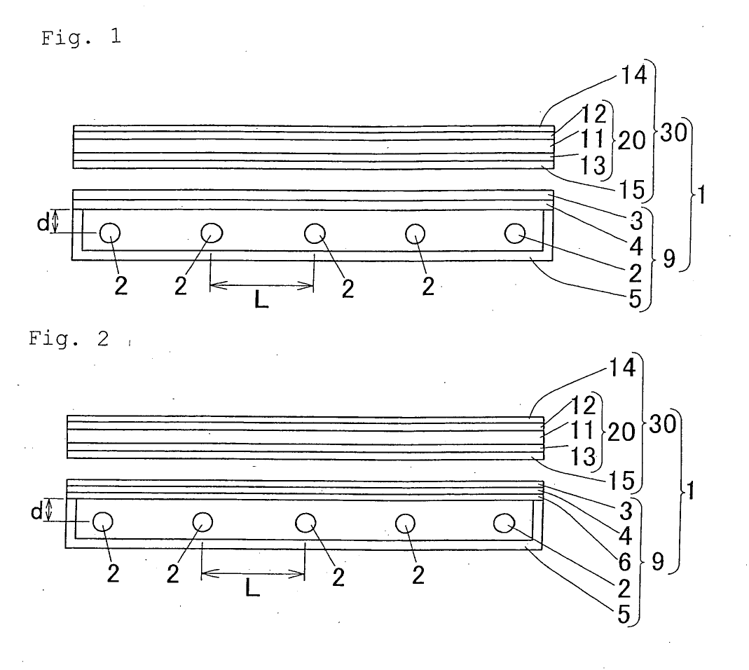

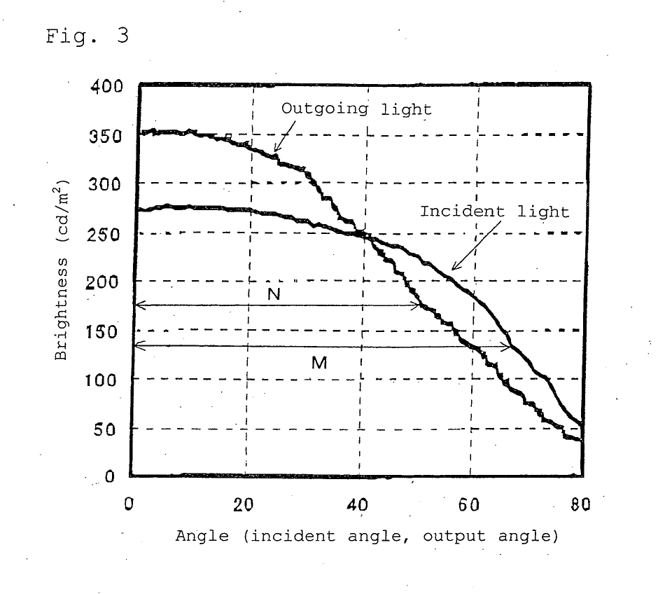

Now, a liquid crystal display device 1 according to another embodiment of the present invention is shown in FIG. 2. This embodiment employs the structure in which a second light diffusing optical member 6 is further arranged between the light converging optical member 4 and the light source 2 of the liquid crystal display device shown in FIG. 1. The other structure is the same as that of the previous embodiment (FIG. 1).

In FIG. 2, this embodiment employs the arrangement in which the light converging optical member 4 and the second light diffusing optical member 6 are superimposed in a contact state, but the present invention is not specifically limited to such arrangement and allows, e.g., a structure in which the light converging optical member 4 and the second light diffusing optical member 6 are arranged in parallel via a slight air layer in a non-contact state.

In the liquid crystal display device 1 shown in FIG. 2, in addition to the aforementioned effect (it becomes possible to attain a natural and high-quality color display not tinged with red when seen in an oblique direction thereof), the lighting unevenness of the light source can be sufficiently concealed due to the arrangement of the second light diffusing optical member 6 arranged between the light converging optical member 4 and the light source 2. This enables to obtain an image more even in brightness within a surface of the liquid crystal panel 30.

The first light diffusing optical member 3 is not limited to a specific one and can be any member as long as it is a sheet, a film, or the like, having a composition in which light diffusing particles are dispersed in a transparent material. The thickness of the first light diffusing optical member 3 is not specifically limited, and is usually 0.05 to 15 mm, preferably 0.05 to 3 mm, more preferably 0.05 to 1 mm.

The transparent material constituting the first light diffusing optical member 3 is not specifically limited, and can be, for example, glass or transparent resin. As the transparent resin, it can be exemplified by, e.g., polycarbonate resin, ABS resin (acrylonitrile-butadiene-styrene resin), metacrylate resin, MS resin (methyl methacrylate-styrene copolymer), polystyrene, AS resin (acrylonitrile-styrene copolymer resin), and polyolefin resin (e.g., polyethylene, polypropylene, cyclic polyolefin resin).

As the light diffusing particles (light diffusing agents) constituting the first light diffusing optical member 3, the particles are not limited to specific ones, and can be any particles so long as the particles are different in refraction index from the transparent material constituting the first light diffusing optical member 3 and can diffuse the light passing therethrough. For example, inorganic particles, such as, e.g., glass beads, silica particles, aluminum hydroxide particles, calcium carbonate particles, barium sulfate particles, titanium oxide particles, or talc, and resin particles, such as, e.g., styrene series polymer particles, acrylic series polymer particles, or siloxane series polymer particles, can be exemplified.

The additive amount of the light diffusing particles is preferably set so as to fall within a range of 0.01 to 20 mass parts, preferably 0.03 to 10 mass parts, especially 5 mass parts or less, with respect to 100 mass parts of the transparent material. By setting the additive amount to 0.01 mass parts or more, sufficient light diffusing function can be secured. By setting the additive amount to 20 mass parts or less, it becomes possible to prevent the bluish degree of the diffused light obliquely passed through the first light diffusing optical member from becoming insufficient.

The 50% cumulative particle diameter (D₅₀) of the light diffusing particles is normally 10 μm or less, and is preferably 0.3 to 8 μm.

The absolute value Δn of the difference between the refraction index of the transparent material and the light diffusing particles is normally set to 0.01 to 0.20, but the preferable range is 0.02 to 0.18.

The first light diffusing optical member 3 can contain various additive agents, such as, e.g., ultraviolet absorbing agent, heat stabilizer, antioxidizing agent, UV stabilizer, light stabilizer, fluorescent brightening agent, or processing stabilizer. It is acceptable to add light diffusing particles other than the light diffusing particles which satisfy the aforementioned specific relational expression so long as the additive amount falls within the range which does not inhibit the effects of the present invention.

A coating layer can be formed on the surface of the first light diffusing optical member 3 within a range which does not inhibit the effects of the present invention. The thickness of the coating layer is preferably set to 20% or less of the thickness of the first light diffusing optical member 3, more preferably 10% or less.

As the manufacturing method of the first light diffusing optical member 3, any know forming methods known as a resin plate forming method can be employed, and although not specifically limited, for example, a thermal press method, a melt extrusion method, and an injection molding method can be exemplified.

The light converging optical member 4 is not limited to a specific one and can be any member so long as it has a light converging function of converging incident light from the light source 2 in a front direction. For example, the light converging optical member can be exemplified by a prism sheet (including “film”) having a light converging function of converging incident light in a front direction, a light diffusing sheet (including “film”) having a light converging function of converging incident light in a front direction, and a surface shaped light diffusing optical member having a light converging function of converging incident light in a front direction.

Among other things, as the light converging optical member 4, it is preferable to use an optical member having the following light converging function. That is, it is preferable to use a light converging optical member having a light converging function (hereinafter, may sometimes be referred to as “specific light converging function) in which, when an incident light having a half width at half maximum of 60° or more, the half width at half maximum being defined as a half of angular range between two points corresponding to a half of a maximum value of brightness of an incident angle-brightness curve showing each brightness of an incident angle of an incident light, is projected to the light conversing optical member, a light conversing performance capable of reducing a half width at half maximum of an output angle-brightness curve of an outgoing light output from the light converging optical member by 10° or more than a half width at half maximum of an incident light (see FIG. 3). For example, the light converging optical member can be exemplified by a prism sheet (including “film”) having the aforementioned specific light converging function, a light diffusing sheet (including “film”) having the aforementioned specific light converging function, and a surface shaped light diffusing optical member having the aforementioned specific light converging function.

Furthermore, as the light converging optical member 4, it is more preferable to use a light conversing optical member having a light converging function in which, when an incident light having a half width at half maximum of 60° or more, the half width at half maximum being defined as a half of angular range between two points corresponding to a half of a maximum value of brightness of an incident light angle-brightness curve showing each brightness of an incident angle of an incident light, is projected to the light conversing optical member, the light conversing performance capable of reducing a half width at half maximum of an output angle-brightness curve of an outgoing light output from the light converging optical member by 15° or more than a half width at half maximum of an incident light.

In the incident angle-brightness curve, the incident angle “0°” denotes a direction perpendicular to the surface (rear surface) of the light converging optical member 4. Furthermore, in the output angle-brightness curve, the output angle “0°” denotes a direction perpendicular to the surface (front surface) of the light converging optical member 4 (see FIG. 3).

The prism sheet (including “film”) 4 is normally made of a transparent resin material. Although not specifically limited, it can be exemplified by, e.g., a sheet (including “film”) having minute light converging lenses, such as, e.g., minute prism lenses, minute converging lenses, or lenticular lenses, provided on one entire surface of the sheet.

As the prism sheet (including “film”), it can be exemplified by a sheet (including “film”) having a substrate made of thermoplastic resin, e.g., polycarbonate resin, ABS resin (acrylonitrile-butadiene-styrene resin), metacrylate resin, methyl methacrylate-styrene copolymer resin, polystyrene resin, acrylonitrile-styrene (AS) copolymer resin, polyethylene resin, and polyolefin resin such as polyolefin resin. As a commercially available product of the prism film 4, although not specifically limited, it can be exemplified by a “BEF (Brightness Enhancement Film) (product name) made by Sumitomo 3M Co., Ltd. (the film is constituted by a polyester film 125 μm in thickness and an acrylic resin layer 30 μm in thickness formed on the polyester film, and V-shaped grooves each having an opening angle of the groove bottom portion of 90 degrees and a depth of 25 μm are formed on the surface of the acrylic resin layer at pitch-intervals of 50 μm), an “ESTINA” (product name) made by Sekisui Film Co., Ltd., and “ILLUMINEX ADF FILM” (product name) made by GE Plastics Co., Ltd.

As the light diffusing sheet (including “film”) 4, although not specifically limited, it can be exemplified by, e.g., a light diffusing sheet (including “film”) in which light diffusing particles are dispersed in a transparent material, and a light diffusing sheet (including “film”) in which light diffusing particles are applied together with a binder on a surface of a substrate sheet made of a transparent material.

As the transparent material constituting the light diffusing sheet (including “film”), although not specifically limited, inorganic glass, transparent resin, etc., can be used. As the transparent resin, it is preferable to use a transparent thermoplastic resin in the light of easy forming. As a transparent thermoplastic resin, although not specifically limited, it can be exemplified by, e.g., polycarbonate resin, ABS resin (acrylonitrile butadiene styrene resin), methacrylic resin, methyl methacrylate-styrene copolymer resin, polystyrene resin, acrylonitrile-styrene copolymer (AS) resin, polyethylene resin, and polyolefin resin such as cyclic polyolefin resin.

As the light diffusing particles constituting the light diffusing sheet (including “film”) 4, the particles are not specifically limited so long as they are particles (including “powder”) which are non-compatible with respect to the transparent material, exhibit a refraction index different from that of the transparent material and have a function of diffusing the light passing through the light diffusing sheet 4, which can be, for example, inorganic particles made of inorganic material or organic particles made of organic material. As the inorganic material constituting the inorganic particles, although not specifically limited, it can be exemplified by, e.g., silica, calcium carbonate, barium sulfate, titanium oxide, aluminum hydroxide, inorganic glass, mica, talc, white carbon, magnesium oxide, and zinc oxide. As an organic material constituting the organic particles, although not specifically limited, the material can be exemplified by, e.g., methacrylate series cross-linked resin, methacrylate series high-molecular-weight resin, styrene series cross-linked resin, styrene series high-molecular-weight resin, and siloxane series polymer. The particle size of the organic particles and inorganic particles used as the light diffusing agent is normally 0.1 to 50 μm. Although different depending on the targeted degree of diffusion of the light passing therethrough, the used amount of the light diffusing particles is normally 0.01 to 20 mass parts, preferably 0.1 to 10 mass parts with respect to 100 mass parts of the transparent resin.

As the surface shaped light diffusing optical member 4, although not specifically limited, it can be exemplified by, for example, a resin sheet (including “film”) having a number of semicircular protrusions semicircular in cross-section or elliptic protrusions approximately ellipsoidal in cross-section formed on the surface of the sheet, a resin sheet (including “film”) having a plurality of triangular ridges triangle in cross-section extending in one direction on the surface of the sheet (one-dimensional type), and a sheet having a plurality of triangular ridges triangle in cross-section extending in two different directions (e.g., two orthogonal oriented directions) (two-dimensional type).

The thickness of the light converging optical member 4 is normally 0.02 to 5 mm, preferably 0.02 to 2 mm, more preferably 0.05 to 1 mm.

As the second light diffusing optical member 6, although not specifically limited, for example, a light diffusing sheet (including “film”) in which light diffusing particles are dispersed in a transparent material can be exemplified.

As the transparent material constituting the light diffusing sheet (including “film”) 6, although not specifically limited, for example, inorganic glass or transparent resin can be used. As the transparent resin, a transparent thermoplastic resin can be preferably used in the light of easy forming. As the transparent thermoplastic resin, although not specifically limited, it can be exemplified by, for example, polycarbonate resin, ABS resin (acrylonitrile-butadiene-styrene copolymer), metacrylate resin, methyl methacrylate-styrene copolymer resin, and polyethylene resin, acrylonitrile-styrene copolymer (AS) resin, polyethylene resin, polypropylene resin, and polyolefin resin such as cyclic polyolefin resin.

As the light diffusing particles constituting the light diffusing sheet (including “film”) 6, the particles are not specifically limited so long as they are particles (including “powder”) which are non-compatible with respect to the transparent material, exhibit a refraction index different from that of the transparent material and have a function of diffusing the light passing through the light diffusing sheet 6, which can be, for example, inorganic particles made of inorganic material or organic particles made of organic material. As the inorganic material constituting the inorganic particles, although not specifically limited, it can be exemplified by, e.g., silica, calcium carbonate, barium sulfate, titanium oxide, aluminum hydroxide, inorganic glass, mica, talc, white carbon, magnesium oxide, and zinc oxide. As an organic material constituting the organic particles, although not specifically limited, the material can be exemplified by, e.g., methacrylate series cross-linked resin, methacrylate series high-molecular-weight resin, styrene series cross-linked resin, styrene series high-molecular-weight resin, and siloxane series polymer. The particle size of the organic particles and inorganic particles used as the light diffusing agent is normally 0.1 to 50 μm. Although different depending on the targeted degree of diffusion of the light passing therethrough, the used amount of the light diffusing particles is normally 0.01 to 20 mass parts, preferably 0.1 to 10 mass parts with respect to 100 mass parts of the transparent resin.

As the transparent electrodes 12 and 13, although not specifically limited, for example, ITO (indium tin oxide) can be exemplified.

As the light source 2, although not specifically limited, for example, a fluorescent lamp, a halogen lamp, a tungsten lamp, and a light-emitting diode can be exemplified.

The distance “L” between adjacent light sources 2 and 2 is preferably set to 10 mm or more from the view point of saving electric power. The distance “d” between the light converging optical member 4 and the light source 2 is preferably set to 50 mm or less from the viewpoint of reducing the thickness. The ratio of “d” to “L” (d:L) is preferably set to 1:5 to 5:1. Especially, it is more preferable that the distance “L” between the adjacent light sources 2 and 2 is set to 10 to 100 mm. Further, the distance “d” between the light conversing optical member 4 and the light source 2 is especially preferably set to 10 to 50 mm. (see FIG. 1).

The liquid crystal display device 1 according to the present invention is not specifically limited to the aforementioned embodiments, and the present invention allow any design modifications so long as they do not deviate from the spirit of the invention and fall within the scope of the invention claimed. Further, the terms and expressions which have been employed herein are used as terms of description and not of limitation, and there is no intent, in the use of such terms and expressions, of excluding any of the equivalents of the features shown and described or portions thereof.

### EXAMPLES

Next, concrete examples of the present invention will be explained, but it should be recognized that the present invention is not limited these embodiments.

### Example 1

100 mass parts of polystyrene resin and 0.1 mass parts of silicone resin particles (light diffusing particles) (product name “XC99-A8808” made by Shin-Etsu Chemical Co., Ltd.) were mixed with a Henshel-Mixer™, and then melt-mixed and extruded with an extruder to thereby produce a first light diffusing optical member 3, or a sheet 2 mm thick. The refraction index of the polystylene resin was 1.59, the refraction index of the silicone resin particle was 1.43, and the absolute value (Δn) of the difference between both the refraction indexes was 0.16. The 50% cumulative particle diameter (D₅₀) of the silicone resin particle was 0.6 μm.

Next, using the first light diffusing optical member 3, a VA type liquid crystal display device 1 as shown in FIG. 1 was produced. As the light source, a fluorescent lamp was used. As the light converging optical member 4, a prism film A in which the apex angle of the prism triangular shape was 90°, the pitch of the adjacent prisms was 48 μm, and the thickness was 230 μm was used. This prism film A had the aforementioned specific light converging performance (i.e., when an incident light having a half width at half maximum of 67° or more, the half width at half maximum being defined as a half of angular range between two points corresponding to a half of a maximum value of brightness of an incident light angle-brightness curve showing each brightness of an incident angle of an incident light, was projected to the prism film, the half width at half maximum of an output angle-brightness curve of an outgoing light output from the prism film was 48°).

### Example 2

Using the same first light diffusing optical member 3 as in Example 1, a VA type liquid crystal display device 1 as shown in FIG. 2 was produced. As the light source 2, a fluorescent lamp was used. As the light converging optical member 4, a prism film A in which the apex angle of the prism triangular shape was 90°, the pitch of the adjacent prisms was 48 μm, and the thickness was 230 μm was used. As the second light diffusing optical member 6, a “SUMIPEX E RM802S” (product name) made by Sumitomo Chemical Co., Ltd. was used.

### Example 3

100 mass parts of polycarbonate resin and 0.5 mass parts of acrylate resin particles (light diffusing particles) were mixed with a Henshel-Mixer™, and then melt-mixed and extruded with an extruder to thereby produce a first light diffusing optical member 3, or a sheet 0.5 mm thick. The refraction index of the polycarbonate resin was 1.59, the refraction index of the acrylate resin particle was 1.49, and the absolute value (Δn) of the difference between both the refraction indexes was 0.10. The 50% cumulative particle diameter (D₅₀) of the acrylate resin particle was 0.9 μm.

Next, using the first light diffusing optical member 3, a VA type liquid crystal display device 1 as shown in FIG. 2 was produced. As a light source 2, alight converging optical member 4, a second light diffusing optical member 6, the same members as in Example 2 were used.

### Example 4

100 mass parts of polycarbonate resin and 1.0 mass parts of acrylate resin particles (light diffusing particles) were mixed with a Henshel-Mixer™, and then melt-mixed and extruded with an extruder to thereby produce a first light diffusing optical member 3, or a sheet 0.5 mm thick. The refraction index of the polycarbonate resin was 1.59, the refraction index of the acrylate resin particle was 1.49, and the absolute value (Δn) of the difference between both the refraction indexes was 0.10. The 50% cumulative particle diameter (D₅₀) of the acrylate resin particle was 0.9 μm.

Next, using the first light diffusing optical member 3, a VA type liquid crystal display device 1 as shown in FIG. 2 was produced. As alight source 2, a light converging optical member 4, and a second light diffusing optical member 6, the same members as in Example 2 were used.

### Example 5

100 mass parts of polycarbonate resin and 1.4 mass parts of acrylate resin particles (light diffusing particles) were mixed with a Henshel-Mixer™, and then melt-mixed and extruded with an extruder to thereby produce a first light diffusing optical member 3, or a sheet 0.5 mm thick. The refraction index of the polycarbonate resin was 1.59, the refraction index of the acrylate resin particle was 1.49, and the absolute value (Δn) of the difference between both the refraction indexes was 0.10. The 50% cumulative particle diameter (D₅₀) of the acrylate resin particle was 0.9 μm.

Next, using the first light diffusing optical member 3, a VA type liquid crystal display device 1 as shown in FIG. 2 was produced. As a light source 2, a light converging optical member 4, and a second light diffusing optical member 6, the same members as in Example 2 were used.

### Example 6

100 mass parts of polycarbonate resin and 0.1 mass parts of acrylate resin particles (“TECHPOLYMER MBX-2 (product name) made by Sekisui Plastics Co., Ltd) (light diffusing particles) were mixed with a Henshel-Mixer™, and then melt-mixed and extruded with an extruder to thereby produce a first light diffusing optical member 3, or a sheet 0.5 mm thick. The refraction index of the polycarbonate resin was 1.59, the refraction index of the acrylate resin particle was 1.49, and the absolute value (Δn) of the difference between both the refraction indexes was 0.10. The 50% cumulative particle diameter (D₅₀) of the acrylate resin particle was 2.4 μm.

Next, using the first light diffusing optical member 3, a VA type liquid crystal display device 1 as shown in FIG. 2 was produced. As a light source 2, alight converging optical member 4, and a second light diffusing optical member 6, the same members as in Example 2 were used.

### Example 7

100 mass parts of polycarbonate resin and 1.0 mass parts of MS resin particles (methyl methacrylate-styrene copolymer resin) (light diffusing particles) were mixed with a Henshel-Mixer™, and then melt-mixed and extruded with an extruder to thereby produce a first light diffusing optical member 3, or a sheet 0.5 mm thick. The refraction index of the polycarbonate resin was 1.59, the refraction index of the MS resin particle was 1.54, and the absolute value (Δn) of the difference between both the refraction indexes was 0.05. The 50% cumulative particle diameter (D₅₀) of the acrylate resin particle was 1.6 μm.

Next, using the first light diffusing optical member 3, a VA type liquid crystal display device 1 as shown in FIG. 2 was produced. As a light source 2, a light converging optical member 4, and a second light diffusing optical member 6, the same members as in Example 2 were used.

### Example 8

100 mass parts of polycarbonate resin and 2.4 mass parts of MS resin particles (methyl methacrylate-styrene copolymer resin) (light diffusing particles) were mixed with a Henshel-Mixer™, and then melt-mixed and extruded with an extruder to thereby produce a first light diffusing optical member 3, or a sheet 0.5 mm thick. The refraction index of the polycarbonate resin was 1.59, the refraction index of the MS resin particle was 1.54, and the absolute value (Δn) of the difference between both the refraction indexes was 0.05. The 50% cumulative particle diameter (D₅₀) of the MS resin particle was 1.6 μm.

Next, using the first light diffusing optical member 3, a VA type liquid crystal display device 1 as shown in FIG. 2 was produced. As a light source 2, a light converging optical member 4, and a second light diffusing optical member 6, the same members as in Example 2 were used.

### Comparative Example 1

In the same manner as in Example 1, a VA type liquid crystal display device was produced except that no light converging optical member 4 was disposed in the VA type crystal display device of Example 1 (the light converging optical member was removed).

### Comparative Example 2

100 mass parts of polystyrene resin and 0.3 mass parts of silicone resin particles (“TOSPEARL 120” (product name) made by Toshiba Silicone Co., Ltd.) (light diffusing particles) were mixed with a Henshel-Mixer™, and then melt-mixed and extruded with an extruder to thereby produce a first light diffusing optical member 3, or a sheet 2 mm thick. The refraction index of the polystylene resin was 1.59, the refraction index of the silicone resin particle was 1.43, and the absolute value (Δn) of the difference between both the refraction indexes was 0.16. The 50% cumulative particle diameter (D₅₀) of the silicone resin particle was 1.7 μm.

Next, using the first light diffusing optical member 3, a VA type liquid crystal display device 1 as shown in FIG. 1 was produced. As the light source 2, a fluorescent lamp was used. As the light converging optical member 4, a prism film A in which the apex angle of the prism triangular shape was 90°, the pitch of the adjacent prisms was 48 μm, and the thickness was 230 μm was used.

### Comparative Example 3

Using the same first light diffusing optical member 3 as in Comparative Example 2, a VA type liquid crystal display device 1 as shown in FIG. 2 was produced. As the light source 2, a fluorescent lamp was used. As the light converging optical member 4, a prism film A in which the apex angle of the prism triangular shape was 90°, the pitch of the adjacent prisms was 48 μm, and the thickness was 230 μm was used. As the second light diffusing optical member 6, a “SUMIPEX E RM802S” (product name) made by Sumitomo Chemical Co., Ltd. was used.

### Comparative Example 4

In the same manner as in Comparative Example 2, a VA type liquid crystal display device was produced except that no light converging optical member 4 was disposed in the VA type crystal display device of Comparative Example 2 (the light converging optical member was removed).

### Comparative Example 5

100 mass parts of polystyrene resin and 2.0 mass parts of acrylate resin particles (“TECHPOLYMER MBX-8 (product name) made by Sekisui Plastics Co., Ltd) (light diffusing particles) were mixed with a Henshel-Mixer™, and then melt-mixed and extruded with an extruder to thereby produce a first light diffusing optical member 3, or a sheet 2 mm thick. The refraction index of the polystyrene resin was 1.59, the refraction index of the acrylate resin particle was 1.49, and the absolute value (Δn) of the difference between both the refraction indexes was 0.10. The 50% cumulative particle diameter (D₅₀) of the acrylate resin particle was 6.0 μm.

Next, using the first light diffusing optical member. 3, a VA type liquid crystal display device 1 as shown in FIG. 1 was produced. As the light source 2, a fluorescent lamp was used. As the light converging optical member 4, a prism film A in which the apex angle of the prism triangular shape was 90°, the pitch of the adjacent prisms was 48 μm, and the thickness was 230 μm was used.

### Comparative Example 6

Using the same first light diffusing optical member 3 as in Comparative Example 5, a VA type liquid crystal display device 1 as shown in FIG. 2 was produced. As the light source 2, a fluorescent lamp was used. As the light converging optical member 4, a prism film A in which the apex angle of the prism triangular shape was 90°, the pitch of the adjacent prisms was 48 μm, and the thickness was 230 μm was used. As the second light diffusing optical member 6, a “SUMIPEX E RM802S” (product name) made by Sumitomo Chemical Co., Ltd. was used.

### Comparative Example 7

In the same manner as in Comparative Example 5, a VA type liquid crystal display device was produced except that no light converging optical member 4 was disposed in the VA type crystal display device of Comparative Example 5 (the light converging optical member was removed).

### Comparative Example 8

100 mass parts of polystyrene resin and 0.5 mass parts of silicone resin particles (“TOSPEARL 145” (product name) made by Toshiba Silicone Co., Ltd.) (light diffusing particles) were mixed with a Henshel-Mixer™, and then melt-mixed and extruded with an extruder to thereby produce a first light diffusing optical member 3, or a sheet 2 mm thick. The refraction index of the polystylene resin was 1.59, the refraction index of the silicone resin particle was 1.43, and the absolute value (Δn) of the difference between both the refraction indexes was 0.16. The 50% cumulative particle diameter (D₅₀) of the silicone resin particle was 3.9 μm.

Next, using the first light diffusing optical member 3, a VA type liquid crystal display device 1 as shown in FIG. 1 was produced. As the light source 2, a fluorescent lamp was used. As the light converging optical member 4, a prism film A in which the apex angle of the prism triangular shape was 90°, the pitch of the adjacent prisms was 48 μm, and the thickness was 230 μm was used.

### Comparative Example 9

Using the same first light diffusing optical member 3 as in Comparative Example 8, a VA type liquid crystal display device 1 as shown in FIG. 2 was produced. As the light source 2, a fluorescent lamp was used. As the light converging optical member 4, a prism film A in which the apex angle of the prism triangular shape was 90°, the pitch of the adjacent prisms was 48 μm, and the thickness was 230 μm was used. As the second light diffusing optical member 6, a “SUMIPEX E RM802S” (product name) made by Sumitomo Chemical Co., Ltd. was used.

### Comparative Example 10

In the same manner as in Comparative Example 8, a VA type liquid crystal display device was produced except that no light converging optical member 4 was disposed in the VA type crystal display device of Comparative Example 8 (the light converging optical member was removed).

### <Method of Measuring the 50% Cumulative Particle Diameter (D₅₀) of the Light Diffusing Particles>

The 50% cumulative particle diameter (D₅₀) of the light diffusing particles was measured by a Fraunhoffer diffraction method for a laser light source forward-scattered light using a Microtrac grain size analyzer (Model: 9220FRA) made by Nikkiso Co., Ltd. In measuring, light diffusing particles of about 0.1 g were dispersed in methanol to obtain a fluid dispersion. Ultrasonic waves were applied to the fluid dispersion for 5 minutes, and then the fluid dispersion was introduced into the Microtrac grain size analyzer through its sample inlet to be measured. In measuring the 50% cumulative particle diameter (D₅₀), the particle size and volume of the entire particles were measured and the volume was integrated sequentially from the smaller particle size. The 50% cumulative particle diameter (D₅₀) denotes a particle size of the particle whose integrated volume was 50% with respect to the total volume of the entire particles.

Each liquid crystal display device obtained as mentioned above was evaluated in accordance with the following evaluating method. The results are shown in Table 1.

TABLE 1

| | First light diffusing | | | | | | |
|---|---|---|---|---|---|---|---|
| | optical member | | | | | | |
| | | Refraction | | | | Chromaticity difference | |
| | | index of light | | | | between oblique direction | |
| | Refraction | diffusing | | D₅₀ | | and front direction | |
| | index of resin | particles | Δn | (μm) | ΔnxD₅₀ | Δx | Δy |
| Ex. 1 | 1.59 | 1.43 | 0.16 | 0.6 | 0.10 | 0.0220 | 0.0363 |
| Ex. 2 | 1.59 | 1.43 | 0.16 | 0.6 | 0.10 | 0.0142 | 0.0266 |
| Ex. 3 | 1.59 | 1.49 | 0.10 | 0.9 | 0.09 | 0.0095 | 0.0200 |
| Ex. 4 | 1.59 | 1.49 | 0.10 | 0.9 | 0.09 | 0.0153 | 0.0211 |
| Ex. 5 | 1.59 | 1.49 | 0.10 | 0.9 | 0.09 | 0.0173 | 0.0232 |
| Ex. 6 | 1.59 | 1.49 | 0.10 | 2.4 | 0.24 | 0.0112 | 0.0201 |
| Ex. 7 | 1.59 | 1.54 | 0.05 | 1.6 | 0.08 | 0.0027 | 0.0153 |
| Ex. 8 | 1.59 | 1.54 | 0.05 | 1.6 | 0.08 | 0.0054 | 0.0249 |
| Comp. Ex. 1 | 1.59 | 1.43 | 0.16 | 0.6 | 0.10 | 0.0308 | 0.0412 |
| Comp. Ex. 2 | 1.59 | 1.43 | 0.16 | 1.7 | 0.27 | 0.0288 | 0.0379 |
| Comp. Ex. 3 | 1.59 | 1.43 | 0.16 | 1.7 | 0.27 | 0.0299 | 0.0365 |
| Comp. Ex. 4 | 1.59 | 1.43 | 0.16 | 1.7 | 0.27 | 0.0323 | 0.0419 |
| Comp. Ex. 5 | 1.59 | 1.49 | 0.10 | 6.0 | 0.60 | 0.0317 | 0.0426 |
| Comp. Ex. 6 | 1.59 | 1.43 | 0.10 | 6.0 | 0.60 | 0.0299 | 0.0380 |
| Comp. Ex. 7 | 1.59 | 1.49 | 0.10 | 6.0 | 0.60 | 0.0323 | 0.0392 |
| Comp. Ex. 8 | 1.59 | 1.43 | 0.16 | 3.9 | 0.62 | 0.0296 | 0.0370 |
| Comp. Ex. 9 | 1.59 | 1.43 | 0.16 | 3.9 | 0.62 | 0.0259 | 0.0367 |
| Comp. Ex. 10 | 1.59 | 1.43 | 0.16 | 3.9 | 0.62 | 0.0323 | 0.0392 |

### <Evaluation Method of Chromaticity Difference Between Oblique Direction and Front Direction>

Using a luminance meter Eye-scale 3W, 4W 9 (made by I system Co., Ltd.), in a state in which the light sources are turned on in each liquid crystal display device, the chromaticity x and the chromaticity y as seen from the front direction)(0° and the chromaticity x and the chromaticity y as seen from the oblique direction)(68° were measured. With these measured results, the front directional chromaticity difference Δx and the oblique directional chromaticity difference Δy were calculated.

Chromaticity differenceΔx=(oblique directional chromaticity x)—(front directional chromaticity x)
Chromaticity differenceΔy=(oblique directional chromaticity y)—(front directional chromaticity y)

In a state in which the liquid crystal panel was caused to display white by a pattern generator (a product of Leader Electronics Corporation), the chromaticity x and y were measured.

As apparent from Table 1, in the liquid crystal display device of Example 1 of the present invention, the chromaticity difference Δx between the oblique direction and the front direction was 0.0220. The chromaticity difference between the oblique direction and the front direction was small. It was confirmed that the display was not tinged with red as seen from the oblique direction as well as from the front direction, and showed a natural high-quality color. In the liquid crystal display devices of Examples 2 to 8 of the present invention (liquid crystal display devices in which a second light diffusing optical member was disposed between the light converging optical member and the light source), the chromaticity difference Δx between the oblique directional chromaticity and the front directional chromaticity was, 0.0142, 0.0095, 0.0153, 0.0173, 0.0112, 0.0027, 0.0054, respectively, and therefore the chromaticity difference between the oblique direction and the front direction was further reduced. Thus, it was confirmed that the display was not tinged with red as seen from the oblique direction as well as from the front direction, and showed a natural higher-quality color.

On the other hand, in the liquid crystal display devices of Comparative Examples 1 to 10 which deviated from the specified range of the present invention, the chromaticity difference Δx between the oblique directional chromaticity and the front directional chromaticity was large, which resulted in a color display tinged with read as seen in the oblique direction.

This application claims priority to Japanese Patent Application No. 2008-310013 filed on Dec. 4, 2008, the disclosure of which is incorporated by reference in its entirety.

### DESCRIPTION OF SYMBOLS

1 liquid crystal display device
2 light source
3 first light diffusing optical member
4 light converging optical member
6 second light diffusing optical member
9 surface light source device
11 liquid crystal
12 transparent electrode
13 transparent electrode
20 liquid crystal cell
30 liquid crystal panel

1. A liquid crystal display device comprising:
a first light diffusing optical member;
a light source arranged on a rear surface side of the first light diffusing optical member; and
a liquid crystal panel arranged on a front surface side of the first light diffusing optical member,
wherein the liquid crystal panel includes a liquid crystal cell in which a liquid crystal is sealed in between a pair of transparent electrodes arranged at a distance from each other, molecules of the liquid crystal being oriented approximately vertically with respect to the transparent electrodes in a state in which no voltage is applied between the pair of transparent electrodes,
wherein the first light diffusing optical member is made of a transparent material in which light diffusing particles are dispersed,
wherein a relational expression of 0.01≦Δn×D₅₀≦0.25 is satisfied, where Δn is an absolute value of a difference between a refraction index of the transparent material and a refraction index of the light diffusing particles, and D₅₀ (μm) is a 50% cumulative particle diameter of the light diffusing particles, and
wherein a light converging optical member is arranged between the first light diffusing optical member and the light source.

2. The liquid crystal display device as recited in claim 1, wherein the light conversing optical member has, when an incident light having a half width at half maximum of 60° or more, the half width at half maximum being defined as a half of angular range between two points corresponding to a half of a maximum value of brightness of an incident angle-brightness curve showing each brightness of an incident angle of an incident light, is projected to the light conversing optical member, a light conversing performance capable of reducing a half width at half maximum of an output angle-brightness curve of an outgoing light output from the light converging optical member by 10° or more than a half width at half maximum of an incident light.

3. The liquid crystal display device as recited in claim 1, wherein the light conversing optical member is a prism sheet,
wherein the prism sheet has, when an incident light having a half width at half maximum of 60° or more is projected to the light conversing optical member, the half width at half maximum being defined as a half of angular range between two points corresponding to a half of a maximum value of brightness of an incident light-brightness curve showing each brightness of an incident angle of an incident light, a light conversing performance capable of reducing a half width at half maximum of an output angle-brightness curve of an outgoing light output from the light converging optical member by 10° or more than a half width at half maximum of an incident light.

4. The liquid crystal display device as recited in claim 1, wherein the light conversing optical member is a light diffusing sheet,
wherein the light diffusing sheet has, when an incident light having a half width at half maximum of 60° or more is projected to the light conversing optical member, the half width at half maximum being defined as a half of angular range between two points corresponding to a half of a maximum value of brightness of an incident light-brightness curve showing each brightness of an incident angle of an incident light, a light conversing performance capable of reducing a half width at half maximum of an output angle-brightness curve of an outgoing light output from the light converging optical member by 10° or more than a half width at half maximum of an incident light.

5. The liquid crystal display device as recited in claim 1, wherein the light conversing optical member is a surface shaped light diffusing optical member, wherein the surface shaped light diffusing optical member has, when an incident light having a half width at half maximum of 60° or more is projected to the light conversing optical member, the half width at half maximum being defined as a half of angular range between two points corresponding to a half of a maximum value of brightness of an incident light-brightness curve showing each brightness of an incident angle of an incident light, a light conversing performance capable of reducing a half width at half maximum of an output angle-brightness curve of an outgoing light output from the light converging optical member by 10° or more than a half width at half maximum of an incident light.

6. The liquid crystal display device as recited in claim 1, wherein a second light diffusing optical member is arranged between the light conversing optical member and the light source.

7. The liquid crystal display device as recited in claim 1, wherein the light source is a light-emitting diode.
